(19) United States
(12) Patent Application Publication
(10) Pub. No.: US 2010/0039470 A1
(43) Pub. Date: Feb. 18, 2010

(54) LIQUID EJECTION DEVICE AND LIQUID EJECTION METHOD

(75) Inventor: Kiyosuke Suzuki, Tokyo (JP)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: Sony Corporation, Tokyo (JP)

(21) Appl. No.: 12/537,305

(22) Filed: Aug. 7, 2009

(30) Foreign Application Priority Data
Aug. 15, 2008 (JP) 2008-209284

(51) Int. Cl. B41J 29/38

(52) U.S. Cl. 347/14

(57) ABSTRACT

A liquid ejection device includes:

a line head having a plurality of liquid chambers storing liquid, heater elements generating bubbles by heating the liquid, and a nozzle ejecting a droplet from the liquid chamber using the bubbles;

an ejection control portion that controls an ejection direction of the droplet to be a direction substantially orthogonal to the transportation direction of a recording medium;

a line scanner that has resolution two or more times as high as resolution of the line head and detects a landing pattern made up of droplets landed on the recording medium; and

control means for detecting a variance pattern of a luminance level of an output signal outputted from the line scanner to detect a deviation of a landing position of the droplet on the basis of the variance pattern and correcting the ejection direction to be a direction in which the deviation is eliminated.

### BACKGROUND OF THE INVENTION

1. Field of the Invention

The present invention relates to a liquid ejection device equipped with a line head that makes an ejection direction of a droplet variable and a scanner that detects the landing position of the droplet and to a liquid ejection method.

2. Description of Related Art

A liquid ejection device described in JP-A-2004-1364 is a so-called ink-jet line printer and a line head is fixed to a device main body in a direction substantially orthogonal to the transportation direction of a recording sheet. The line head fixed to the device main body forms a certain image on a recording sheet by ejecting ink droplets from nozzles by applying energy to ink within liquid chambers. The line head has a pair of heater elements provided in each liquid chamber and makes an ejection direction of an ink droplet variable in a direction (main scanning direction) orthogonal to the transportation direction of a recording sheet by providing a difference in energy to be applied to the respective heater elements. This configuration enables the line head to form an image at recoding density higher than a nozzle pitch.

Meanwhile, when the line head fails to eject ink droplets to predetermined positions, for example, when ink droplets are not ejected perpendicularly to the ejection surface, a white streak is formed in a print material in the same direction as the transportation direction of a recording sheet. In addition, when any of the nozzles of the line head is clogged with ink and becomes unable to eject ink droplets, a white streak is formed in this case, too. Further, when the line head fails to eject ink droplets to predetermined positions or a nozzle incapable of ejecting ink droplets is present, density of the formed image becomes irregular.

The device described in JP-A-2004-1364 supra controls the ejection direction of ink by supplying energy to a pair of heater elements within each liquid chamber while providing a difference in energy. According to this configuration, even when ink droplets do not land on the predetermined positions, it is possible to correct the ejection direction of ink droplets by applying different energy to a pair of the heater elements within each liquid chamber according to a deviation.

Incidentally, the flight characteristic of ink droplets differs from one product to another or due to factors, such as deterioration with time. Accordingly, in order to form a high-quality image, it is necessary to confirm the flight characteristic for each product or at regular periods or every time printing is performed.

### SUMMARY OF THE INVENTION

It is desirable to provide a liquid ejection device and a liquid ejection method capable of exactly correcting the ejection direction of a droplet by precisely detecting a landing pattern formed on a recording medium.

According to an embodiment of the present invention, there is provided a liquid ejection device including: a line head that has a plurality of liquid chambers storing liquid, heater elements provided at least in a pair aligned side by side in each liquid chamber to generate bubbles by heating the liquid stored in the liquid chamber, and a nozzle that is provided at a position substantially opposing a plurality of the heater elements within each liquid chamber and ejects a droplet from the liquid chamber using the bubbles generated by the heater elements, and is provided to be substantially orthogonal to a transportation direction of a recording medium on which the droplet is to land; an ejection control portion that controls an ejection direction of the droplet ejected from the nozzle to be a direction substantially orthogonal to the transportation direction of the recording medium by providing a difference in energy to be applied to the plurality of the heater elements within each liquid chamber; a line scanner that has resolution two or more times as high as resolution of the line head and is provided to be substantially orthogonal to the transportation direction of the recording medium to detect a landing pattern made up of droplets landed on the recording medium; and control means for detecting a variance pattern of a luminance level of an output signal outputted from the line scanner to detect a deviation of a landing position of the droplet on the basis of the variance pattern of the luminance level and for correcting the ejection direction of the droplet to be a direction in which the deviation is eliminated by controlling the ejection control portion.

According to another embodiment of the present invention, there is provided a liquid ejection method including the steps of: ejecting a droplet on a recording medium, using a line head that has a plurality of liquid chambers storing liquid, heater elements provided at least in a pair aligned side by side in each liquid chamber to generate bubbles by heating the liquid stored in the liquid chamber, and a nozzle that is provided at a position substantially opposing a plurality of the heater elements within each liquid chamber and ejects the droplet from the liquid chamber using the bubbles generated by the heater elements, and is provided to be substantially orthogonal to a transportation direction of the recording medium on which the droplet is to land, while controlling an ejection direction of the droplet ejected from the nozzle to be a direction substantially orthogonal to the transportation direction of the recording medium by providing a difference in energy to be applied to the plurality of the heater elements within each liquid chamber; detecting a landing pattern made up of droplets landed on the recording medium using a line scanner having resolution two or more times as high as resolution of the line head and provided to be substantially orthogonal to the transportation direction of the recording medium; and detecting a variance pattern of a luminance level of an output signal outputted from the line scanner to detect a deviation of a landing position of the droplet on the basis of the variance pattern of the luminance level and correcting the ejection direction of the droplet to be a direction in which the deviation is eliminated.

According to still another embodiment of the present invention, there is provided a liquid ejection device including: a line head that has a plurality of liquid chambers storing liquid, heater elements provided at least in a pair aligned side by side in each liquid chamber to generate bubbles by heating the liquid stored in the liquid chamber, and a nozzle that is provided at a position substantially opposing a plurality of the heater elements within each liquid chamber and ejects a droplet from the liquid chamber using the bubbles generated by the heater elements, and is provided to be substantially orthogonal to a transportation direction of a recording medium on which the droplet is to land; an ejection control portion that controls an ejection direction of the droplet ejected from the nozzle to be a direction substantially orthogonal to the transportation direction of the recording medium by providing a difference in energy to be applied to the plurality of the heater elements within each liquid chamber; a scanner that has resolution two or more times as high as resolution of the line head and is configured to move in a direction substantially orthogonal to the transportation direction of the recording medium to detect a landing pattern made up of droplets landed on the recording medium; and control means for detecting a variance pattern of a luminance level of an output signal outputted from the scanner to detect a deviation of a landing position of the droplet on the basis of the variance pattern of the luminance level and for correcting the ejection direction of the droplet to be a direction in which the deviation is eliminated by controlling the ejection control portion.

According to still another embodiment of the present invention, there is provided a liquid ejection method including the steps of: ejecting a droplet on a recording medium, using a line head that has a plurality of liquid chambers storing liquid, heater elements provided at least in a pair aligned side by side in each liquid chamber to generate bubbles by heating the liquid stored in the liquid chamber, and a nozzle that is provided at a position substantially opposing a plurality of the heater elements within each liquid chamber and ejects the droplet from the liquid chamber using the bubbles generated by the heater elements, and is provided to be substantially orthogonal to a transportation direction of the recording medium on which the droplet is to land, while controlling an ejection direction of the droplet ejected from the nozzle to be a direction substantially orthogonal to the transportation direction of the recording medium by providing a difference in energy to be applied to the plurality of the heater elements within each liquid chamber; detecting a landing pattern made up of droplets landed on the recording medium by moving a scanner having resolution two or more times as high as resolution of the line head in a direction substantially orthogonal to the transportation direction of the recording medium; and detecting a variance pattern of a luminance level of an output signal outputted from the scanner to detect a deviation of a landing position of the droplet on the basis of the variance pattern of the luminance level and correcting the ejection direction of the droplet to be a direction in which the deviation is eliminated.

According to still another embodiment of the present invention, there is provided a liquid ejection device including: a line head that has a plurality of liquid chambers storing liquid, heater elements provided at least in a pair aligned side by side in each liquid chamber to generate bubbles by heating the liquid stored in the liquid chamber, and a nozzle that is provided at a position substantially opposing a plurality of the heater elements within each liquid chamber and ejects a droplet from the liquid chamber using the bubbles generated by the heater elements, and is provided to be substantially orthogonal to a transportation direction of a recording medium on which the droplet is to land; an ejection control portion that controls an ejection direction of the droplet ejected from the nozzle to be a direction substantially orthogonal to the transportation direction of the recording medium by providing a difference in energy to be applied to the plurality of the heater elements within each liquid chamber; a scanner that has resolution substantially as high as resolution of the line head and detects a landing pattern made up of droplets landed on the recording medium; and control means for detecting a variance pattern of a luminance level of an output signal outputted from the scanner to detect a deviation of a landing position of the droplet on the basis of the variance pattern of the luminance level and for correcting the ejection direction of the droplet to a direction in which the deviation is eliminated. The ejection control means forms the landing pattern on the recording medium by causing droplets to be ejected at half or below half the resolution of the scanner so that the landing pattern is detected by the scanner.

According to still another embodiment of the present invention, there is provided a liquid ejection method including the steps of: ejecting a droplet on a recording medium, using a line head that has a plurality of liquid chambers storing liquid, heater elements provided at least in a pair aligned side by side in each liquid chamber to generate bubbles by heating the liquid stored in the liquid chamber, and a nozzle that is provided at a position substantially opposing a plurality of the heater elements within each liquid chamber and ejects the droplet from the liquid chamber using the bubbles generated by the heater elements, and is provided to be substantially orthogonal to a transportation direction of the recording medium on which the droplet is to land, while controlling an ejection direction of the droplet ejected from the nozzle to be a direction substantially orthogonal to the transportation direction of the recording medium by providing a difference in energy to be applied to the plurality of the heater elements within each liquid chamber; detecting a landing pattern made up of droplets landed on the recording medium using a scanner having resolution substantially as high as resolution of the line head; and detecting a variance pattern of a luminance level of an output signal outputted from the scanner to detect a deviation of a landing position of the droplet on the basis of the variance pattern of the luminance level and correcting the ejection direction of the droplet to a direction in which the deviation is eliminated. The line head forms the landing pattern on the recording medium by causing droplets to be ejected at half or below half the resolution of the scanner so that the landing pattern is detected by the scanner.

According to the embodiments of the present invention, by setting the resolution of the scanner two or more times as high as the resolution of the line head or by driving the line head at half or below half the resolution of the scanner, it becomes possible to exactly correct the ejection direction of a droplet by precisely detecting the landing pattern formed on a recording medium.

### BRIEF DESCRIPTION OF THE DRAWINGS

FIG. 1 is a perspective view showing a printer device to which an embodiment of the present invention is applied;

FIG. 2 is a perspective view showing a head cartridge and a scanner of the printer device to which an embodiment of the present invention is applied;

FIG. 3 is an exploded perspective view showing a head chip of the head cartridge;

FIG. 4 is a plan view showing the head chip provided with pairs of heat elements;

FIG. 5 is across section showing a state where ink bubbles of substantially the same size are generated within an ink liquid chamber;

FIG. 6 is a cross section showing a state where an ink droplet is ejected from a nozzle substantially directly below by two ink bubbles;

FIG. 7 is across section showing a state where ink bubbles of different sizes are generated within the ink liquid chamber;

FIG. 8 is a cross section showing a state where an ink droplet is ejected from a nozzle in an substantially diagonal direction by two ink bubbles;

FIG. 9 is a block diagram of an ink-jet printer device;

FIG. 10 is a circuit diagram of an ejection control portion;

FIG. 11 is a view showing ON and OFF states of a polarity conversion switch and first ejection control switches and a variance of the landing position of a dot in a nozzle alignment direction in a tabular form;

FIG. 12 is a view showing ejection directions of ink droplets and a distribution state of landing positions when control by the first ejection control switches and second ejection control switches is performed in a case where there are even-numbered ejection directions of ink droplets;

FIG. 13 is a view showing ejection directions of ink droplets and a distribution state of the dot landing positions when control by the first ejection control switches and the second ejection control switches is performed in a case where there are odd-numbered ejection directions of ink droplets;

FIG. 14A shows a landing pattern according to test data, FIG. 14B shows pixel positions read by a line scanner, and FIG. 14C shows an output from a line scanner for the landing pattern, that is, a luminance level;

FIG. 15 is a perspective view showing a head cartridge and a scanner of a printer device configured in such a manner that the scanner moves in the width direction of a recording sheet; and

FIG. 16A shows a landing pattern according to test data when the resolution of the line head is set to half, FIG. 16B shows pixel positions read by the scanner, and FIG. 16C shows an output from the scanner for the landing pattern, that is, the luminance level.

### DESCRIPTION OF THE PREFERRED EMBODIMENTS

Hereinafter, an ink-jet printer device (hereinafter, referred to as the printer device) 1 to which the present invention is applied will be described concretely with reference to the drawings.

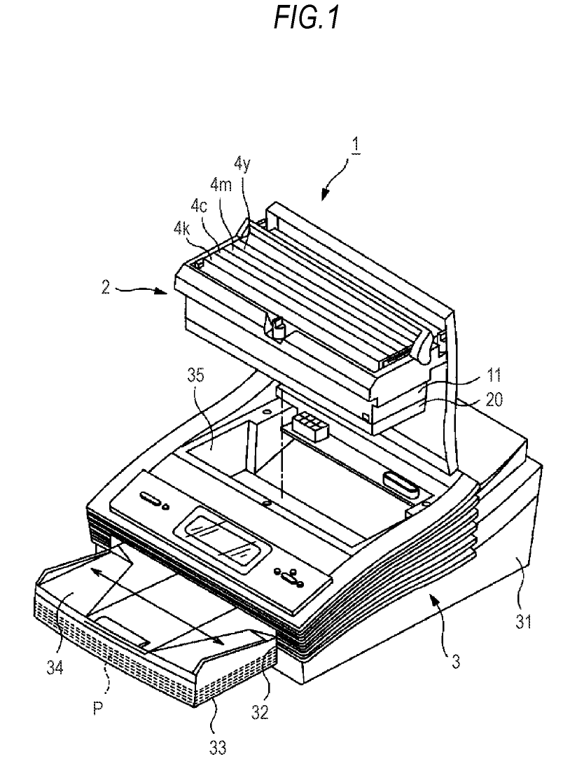

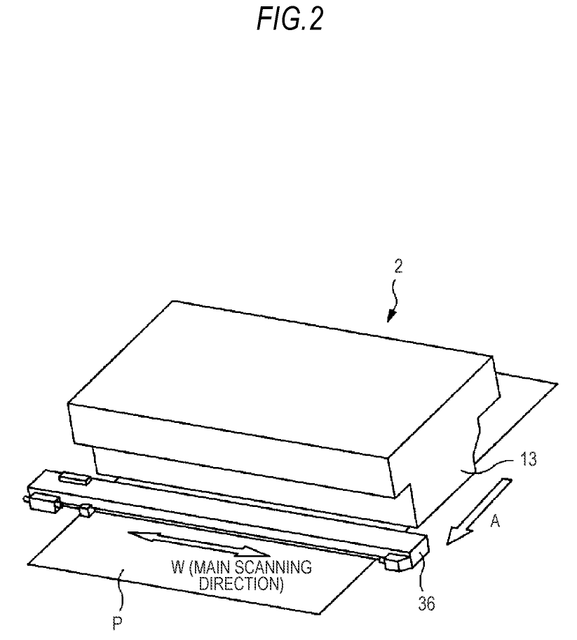

As are shown in FIG. 1 and FIG. 2, the printer device 1 is an ink-jet printer, which is a so-called line-type printer device in which ink nozzles (nozzles) of respective colors are provided side by side substantially linearly in the width direction of a recording sheet P, that is, in the direction indicated by an arrow W of FIG. 1. The printer device 1 includes a head cartridge 2 that ejects ink i and a device main body 3 to which the head cartridge 2 is attached. The head cartridge 2 is attachable to and detachable from the device main body 3.

The head cartridge 2 forming the printer device 1 will be described first. The head cartridge 2 ejects ink i using heat elements for the ink i to land on the principal surface of a recording sheet P. Ink tanks 4 storing the ink i are attached to the head cartridge 2. The ink tanks 4 attached to the head cartridge 2 include a total of four tanks aligned side by side as a yellow ink tank (4y), a magenta ink tank (4m), a cyan ink tank (4c), and a black ink tank (4k).

The head cartridge 2 to which are attached the ink tanks 4 has a cartridge main body 11. The cartridge main body 11 is provided with an attachment portion 12 to which the ink tanks 4 are attached and a line head 13 that ejects the ink i. Further, ahead cap 20 that protects the line head 13 is attached thereto. The head cap 20 opens the line head 13 only when an image is printed and closes the line head 13 when not in use.

Regarding the attachment portion 12 to which the ink tanks 4 are attached, when the four ink tanks 4 are aligned in parallel with one another and attached to the attachment portion 12, each ink tank 4 is connected to a connection portion. The ink i is thus supplied to the line head 13 while an amount of each ink i is adjusted. The line head 13 is provided to the bottom surface of the cartridge main body 11. In the line head 13, nozzles that eject the ink i of respective colors supplied from the connection portion are formed substantially linearly in parallel with one another in the width direction of a recording sheet P, that is, in the direction (main scanning direction) indicated by the arrow W of FIG. 1. When the line head 13 ejects the ink i, it ejects the ink i from one nozzle line at a time without moving in the width direction of a recording sheet P. Accordingly, it is not necessary to move the head as in a serial-type printer device that performs printing by moving the head in the width direction (W direction) of a recording sheet P. An image printing time can be therefore shortened markedly.

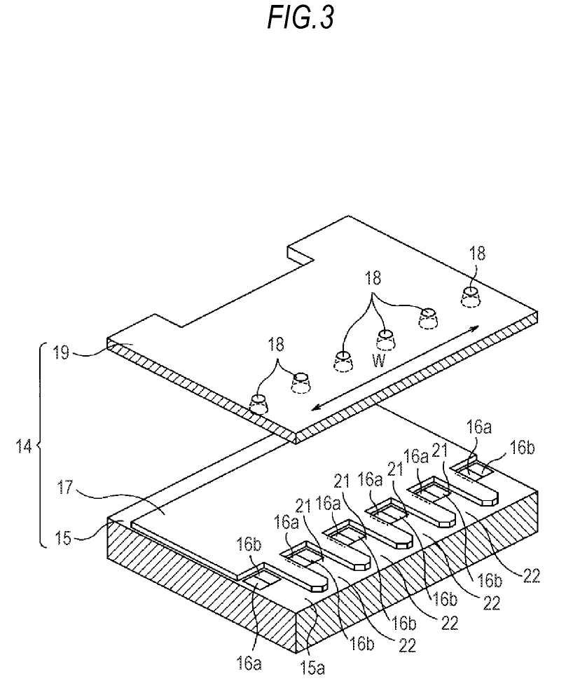

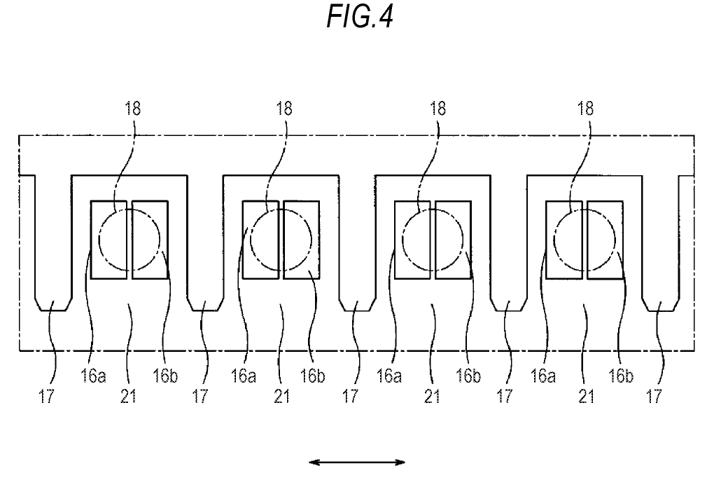

The line head 13 has a head chip 14 formed of a semiconductor substrate on which heat elements are formed. As are shown in FIG. 3 and FIG. 4, the head chip 14 has a circuit board 15, which is a silicon substrate, provided with more than hone pair of heat elements 16a and 16b that are aligned side by side in a direction substantially orthogonal to the travel direction of a recording sheet P, that is, the width direction of a recording sheet P, for the ink i of respective colors. A film 17 that prevents leakage of the ink i and a nozzle sheet 19 provided with many nozzles 18 that eject the ink i in a state of droplets are layered on the circuit board 15. Regions surrounded by the circuit board 15, the film 17, and the nozzle sheet 19 define ink chambers 21 to which the ink i is supplied and ink channels 22 that supply the corresponding ink chambers 21 with the ink i.

The circuit board 15 is a semiconductor substrate made of silicon and pairs of the heat elements 16a and 16b that generate bubbles for ejecting the ink i are formed on one principal surface 15a. Each pair of the heat elements 16a and 16b is connected to an ejection control portion formed of a logic IC (Integrated Circuit) and a driver transistor on the circuit board 15. Each pair of the heat elements 16a and 16b generates heat with a supply of a pulse current and generates bubbles by heating the ink i within the corresponding liquid chamber 21 with application of thermal energy to raise the internal pressure. The heated ink i is thus ejected in a state of a droplet from the corresponding nozzle 18 provided to the nozzle sheet 19.

The film 17 is layered on the one principal surface 15a of the circuit board 15 provided with pairs of the heat elements 16a and 16b at positions corresponding to the respective ink chambers 21. The film 17 is made of dry film resist, for example, of the light exposure setting type. After it is layered on the one principal surface 15a of the circuit board 15 substantially entirely, unwanted portions are removed by a photoligraphy process, so that it surrounds pairs of the heat elements 16a and 16b in a substantially concave shape. A portion of the film 17 that surrounds each pair of the heat elements 16a and 16b forms a part of the corresponding ink liquid chamber 21.

The nozzle sheet 19 is a sheet member provided with the nozzles 18 that eject ink droplets i and having a thickness of about 10 μm to 15 μm, and it is further layered on the film 17 that is layered on the circuit substrate 15. Each nozzle 18 is a fine hole opened in the nozzle sheet 19 in a circular shape having a diameter of about 15 μm to 18 μm, and it is formed oppositely to the corresponding pair of the heat elements 16a and 16b. It should be noted that the nozzle sheet 19 forms a part of the ink liquid chambers 21.

Each of the ink liquid chambers 21 defined by layering the film 17 and the nozzle sheet 19 on the circuit board 15 serves as a space portion that stores the ink i supplied from the corresponding ink channel 22. The internal pressure is increased as the ink i is heated by the corresponding pair of the heat elements 16a and 16b provided oppositely to the corresponding nozzle 18. The ink i is thus ejected from the nozzle 18 in a state of a droplet. The ink channels 22 are connected to the connection portion of the attachment portion 12 and the ink i is supplied from the ink tanks 4 connected to the connection portion. The ink i is thus supplied to the respective ink liquid chambers 21 communicating with the corresponding ink channels 22.

The head chip 14 described above is provided with a pair of the heat elements 16a and 16b in each ink liquid chamber 21 and about 100 to 5000 ink liquid chambers 21 each provided with a pair of the heat elements 16a and 16b are provided for each of the ink tanks 4 of the respective colors. According to an instruction from the control portion in the printer device 1, the head chip 14 selects a pair of the heat elements 16a and 16b appropriately to generate heat, so that the ink i within the ink liquid chamber 21 corresponding to this pair of the heat elements 16a and 16b that are generating heat is ejected in a state of a droplet from the nozzle 18 corresponding to this ink liquid chamber 21.

To be more concrete, each ink liquid chamber 21 is constantly filled with the ink i supplied from the corresponding ink channel 22. When the corresponding pair of the heat elements 16a and 16b generates heat abruptly due to a pulse current at an interval, for example, of 1 μsec to 3 μsec, the ink i in a portion in contact with the pair of the heat elements 16a and 16b is heated and ink bubbles in a gaseous phase are generated. A given volume of the ink i is pressed by the ink bubbles as they swell (the ink i boils). Consequently, the ink i of a volume equal to the volume of the ink i pressed by the ink bubbles in the portion in contact with the nozzle 18 is ejected from the nozzle 18 as an ink droplet i.

As is shown in FIG. 4, in the head chip 14, a pair of the heat elements 16a and 16b is provided within a single ink liquid chamber 21 in such a manner that the heat elements 16a and 16b are aligned side by side substantially in parallel with each other in the width direction of a recording sheet P indicated by an arrow W of FIG. 3. When the ink i within each ink liquid chamber 21 is ejected from the corresponding nozzle 18, by driving the corresponding pair of the heat elements 16a and 16b under the control in such a manner that a time until the ink i within the ink liquid chamber 21 is boiled by the pair of the heat elements 16a and 16b, that is, a bubble generation time, becomes equal for each heat element, the ink droplet i is ejected from the nozzle 18 substantially directly below. In addition, in a case where a time difference occurs in the bubble generation time by the pair of the heat elements 16a and 16b, an ink bubble generated on either one of the heat elements 16a and 16b becomes larger than the one generated on the other. This gives rise to a pressure difference and an ink droplet i is ejected as it is deviated to either one side in the direction in which the pair of the heat elements 16a and 16b is aligned.

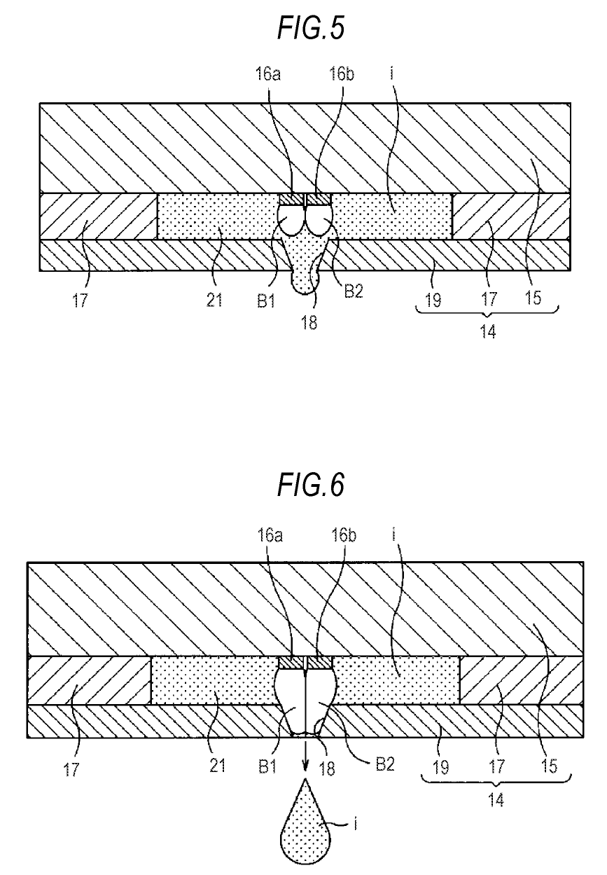

To be more concrete, as are shown in FIG. 5 and FIG. 6, when pulse currents at the same current value are supplied, a pair of the heat elements 16a and 16b is heated abruptly in the same manner and ink bubbles B1 and B2 in a gaseous phase are grown in the same manner from the ink i in portions in contact with the pair of the heat elements 16a and 16b. A predetermined volume of the ink i is thus pressed by the ink bubbles B1 and B2 as they swell. Consequently, the ink i is ejected from the corresponding nozzle 18 substantially directly below in a state of a droplet and lands on the recording sheet P.

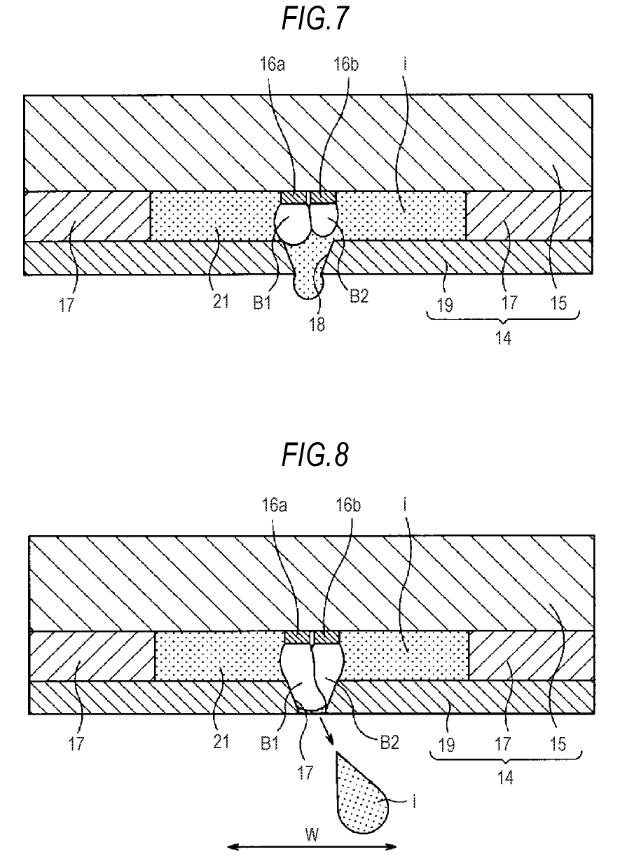

Also, as are shown in FIG. 7 and FIG. 8, when pulse currents at different values are supplied to a pair of the heat elements 16a and 16b, a pair of the heat elements 16a and 16b generates ink bubbles B1 and B2 of different sizes in portions in contact with the heat elements 16a and 16b. A predetermined volume of the ink i is then pressed by the ink bubbles B1 and B2 as they swell. Consequently, the ink i is ejected from the corresponding nozzle 18 in a state of an ink droplet i while being deviated toward either the ink bubble B1 or B2, whichever has the smaller volume, in the width direction (main scanning direction) of a recording sheet P indicated by an arrow W of FIG. 8 and lands on the recording sheet P.

It should be appreciated that the number of the heat elements is not limited to two as specified above and three or more heat elements can be used.

The device main body 3 to which is attached the head cartridge 2 configured as above will now be described with reference to FIG. 1. The device main body 3 is assembled to the interior of an outer casing 31. A paper discharge port 32 through which to discharge recording sheets P is provided to the front face of the outer casing 31. An accommodation tray 33 that stores recording sheets P before printing is attached to the sheet discharge port 32 on the lower side. A sheet discharge tray 34 on which to discharge printed recording sheets P is attached onto the accommodation tray 33.

As is shown in FIG. 1, the outer casing 31 is provided with a head attachment portion 35 to which the head cartridge 2 described above is attached. When the head cartridge 2 is attached to the head attachment portion 35, the ejection surface of the head cartridge 2 is faced to a platen at the print position inside the device main body 3.

Also, as is shown in FIG. 2, a line scanner 36 is provided to the device main body 3 in a direction orthogonal to the transportation direction A of a recording sheet P, that is, in the main scanning direction. As with the line head 13, the line scanner 36 has the dimension substantially the same as the dimension of a recording sheet P in the width direction and reads one line of an image without moving in the width direction (W direction) of a recording sheet P. The line scanner 36 has reading resolution at which an image can be read at resolution two or more times as high as the resolution of the line head 13.

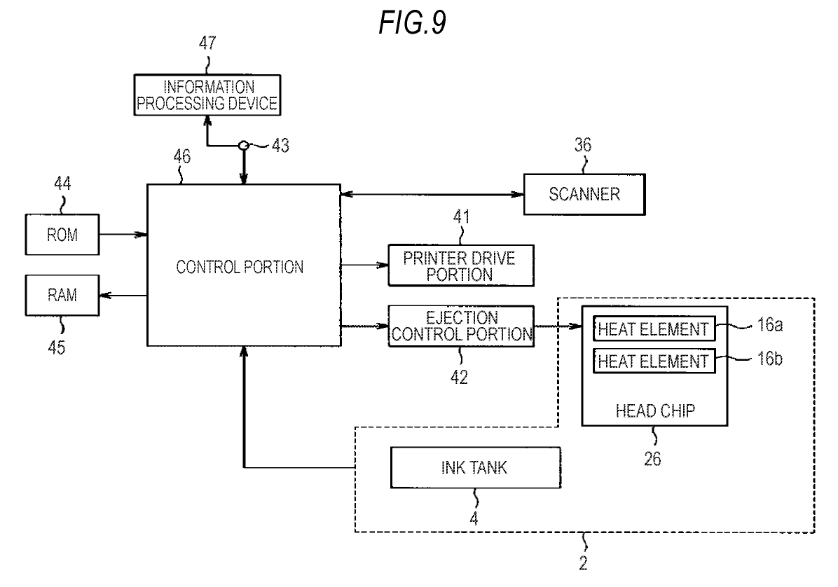

The circuit configuration of the printer device 1 configured as above will now be described with reference to FIG. 9.

The printer device 1 includes a printer drive portion 41 that drives respective drive sources, such as a drive motor of a paper feeding and discharging mechanism in the device main body 3 described above under its control, an ejection control portion 42 that controls a current to be supplied to head chips 26 corresponding to the ink i of respective colors, an input and output terminal 43 that inputs a signal into and receives an output signal from an external device, a ROM (Read Only Memory) 44 that has stored a control program, a RAM (Random Access Memory) 45 that is used to load the control program that has been read out, and a control portion 46 that controls the respective portions.

The printer drive portion 41 drives the drive motor forming the paper feeding and discharging mechanism under its control according to a control signal from the control portion 46 to feed a recording sheet P from the accommodation tray 43 in the device main body 3 and to discharge the printed recording sheet P onto the sheet discharge tray 44.

The input and output terminal 43 transmits information, such as the print conditions specified above, a printing state, and an amount of remaining ink, to an external information processing device 47 via the interface. Also, the input and output terminal 43 receives a controls signal that outputs information, such as the print condition specified above, a printing state, and an amount of remaining ink, and print data inputted therein from the external information processing device 47. Herein, the information processing device 47 is an electronic device, for example, a personal computer or a PDA (Personal Digital Assistant).

The control portion 46 controls the respective portions according to print data inputted therein from the input and output terminal 43. The control portion 46 reads out from the ROM 44 a processing program that controls the respective portions according to a control signal inputted therein and stores the program in the RAM 45. The control portion 46 then controls the respective portions and performs processing according to this processing program.

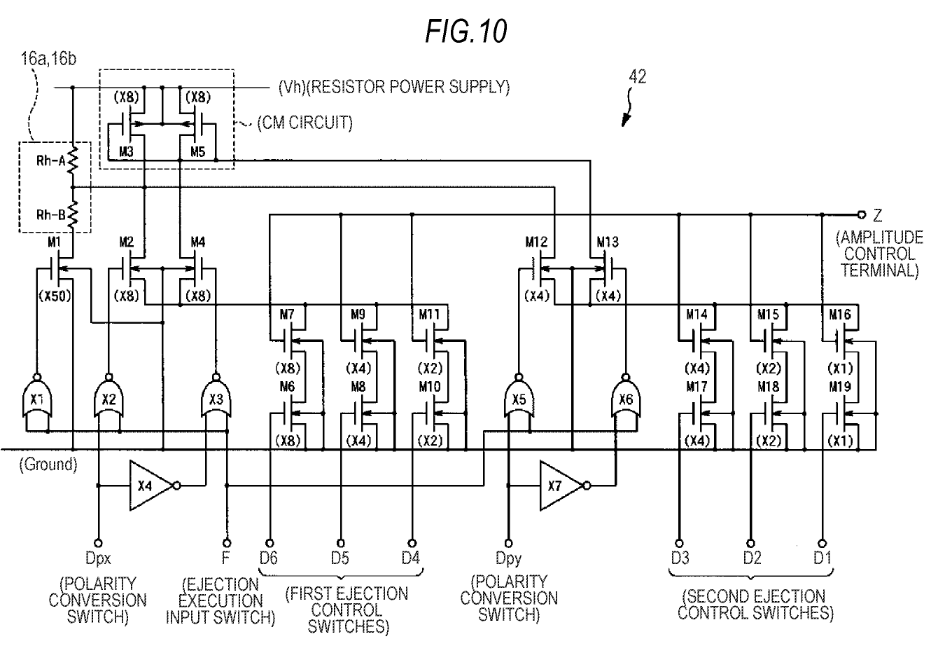

The ejection control portion 42 that controls a current to be supplied to the head chip 26 is configured as shown in FIG. 10. More specifically, in the ejection control portion 42 shown in FIG. 10, resistors Rh-A and Rh-B are respectively the heat elements 16a and 16B divided into two inside the corresponding ink liquid chamber 21 and they are connected in series. Herein, the electrical resistance values of the respective heat elements 16a and 16b are set to substantially the same value. Hence, by flowing a current of the same amount into the heat elements 16a and 16b connected in series, it becomes possible to eject an ink droplet directly below from the corresponding nozzle 18.

Meanwhile, a current mirror circuit (hereinafter, denoted as the CM circuit) is connected between the two heat elements 16a and 16b connected in series. By either flowing a current into between the heat elements 16a and 16b or flowing out a current from between the heat elements 16a and 16b via the CM circuit, a difference is provided in an amount of a current flowing through the respective heat elements 16a and 16b. Owing to this difference, it becomes possible to make the ejection direction of an ink droplet ejected from the nozzle 18 variable in a direction orthogonal to the transportation direction of a recording sheet P.

Also, a resistor power supply Vh is a power supply that provides the resistors Rh-A and Rh-B with a voltage. Further, the ejection control portion 42 includes M1 through M19 as transistors.

Numerals inside the parentheses, “xN (N=1, 2, 4, 8 or 50)”, attached to the respective transistors M1 through M19 indicate a state of parallel alignment of the elements. For example, “x1” (transistors M16 and M19) indicates that the corresponding transistors have a standard element. Likewise, “x2” indicates that the corresponding transistors have an element equivalent to two standard elements connected in parallel. Hereinafter, “xN” indicates that the corresponding transistor has an element equivalent to N standard elements connected in parallel.

The transistor M1 functions as a switching element that turns ON and OFF a supply of a current to the resistors Rh-A and Rh-B. It comes ON to flow a current to the resistors Rh-A and Rh-B when the drain thereof is connected to the resistor Rh-B in series and 0 is inputted into an ejection execute input switch F. The ejection execute input switch F is a negative logic for the reason of the IC design and 0 is inputted therein at the time of driving (only when an ink droplet is ejected). When F=0 is inputted, the input to a NOR gate X1 is (0, 0) and the output is therefore 1. The transistor M1 thus comes ON.

Polarity conversion switches Dpx and Dpy determine whether the ejection direction of an ink droplet is rightward or leftward in the alignment direction of the nozzles 18, that is, in the width direction of a recording sheet P. Further, first ejection control switches D4, D5, and D6 and second ejection control switches D1, D2, and D3 determine an amount of deflection when an ink droplet is deflected and ejected.

Each of the transistors M2 and M4 and the transistors M12 and M13 functions as an operating amplifier (switching element) of a CM circuit formed of the transistors M3 and M5. More specifically, the transistors M2 and M4 and the transistors M12 and M13 flow a current into between the resistors Rh-A and Rh-B or flow out a current from between the resistors Rh-A and Rh-B via the CM circuit.

Further, each of the transistors M7, M9, and M11 and the transistors M14, M15, and M16 serves as a constant current source of the CM circuit. The drains of the respective transistors M7, M9, and M11 are connected the sources and the back gates of the transistors M2 and M4. Likewise, the drains of the respective transistors M14, M15, and M16 are connected to the sources and the back gates of the transistors M12 and M13.

Of these transistors functioning as the constant current source elements, the transistor M7 has a capacity of “x8”, the transistor M9 has a capacity of “x4”, and the transistor M11 has a capacity of “x2”. When connected in parallel, these three transistors M7, M9, and M11 form a current source element group. Likewise, the transistor M14 has a capacity of “x4”, the transistor M15 has a capacity of “x2”, and the transistor M16 has a capacity of “x1”. When connected in parallel, these three transistors M14, M15, and M16 form a current source element group.

Further, the transistors having the same current capacities (transistors M6, M8, M10 and transistors M17, M18, and M19) are connected to the transistors M7, M9, M11 and the transistors M14, M15, and M16 each functioning as the current source element. The first ejection control switches D6, D5, and D4 and the second ejection control switches D3, D2, and D1 are connected to the gates of the transistors M6, M8, and M10 and the transistors M17, M18 and M19, respectively.

Accordingly, for example, when the first ejection control switch D6 is switched ON and an adequate voltage (Vx) is applied between an amplitude control terminal Z and the ground, the transistor M6 comes ON. Hence, a current when the voltage Vx is applied flows into the transistor M7. In this manner, by controlling the switching ON and OFF of the first ejection control switches D6, D5, and D4 and the second ejection control switches D3, D2, and D1, it becomes possible to control the ON and OFF switching of the respective transistors M6 through M11 and the transistors M14 through M19.

Herein, the number of elements connected to the transistors M7, M9, and M11 and the transistors M14, M15, and M16 in parallel is different. In FIG. 10, a current flows into the transistors M2 through M7, the transistors M2 through M9, the transistors M2 through M11, the transistors M12 through M14, the transistors M12 through M15, and the transistors M12 through M16 at a ratio of numbers specified inside the parentheses attached to the respective transistors M7, M9, M11 and the transistors M14, M15, and M16.

Accordingly, because numerals representing the ratio of the transistors M7, M9, and M11 are “x8”, “x4”, and “x2”, respectively, the ratio of the corresponding drain current Id is 8:4:2. Likewise, because numbers representing the ratio of the transistors M14, M15, and M16 are “x4”, “x2”, and “x1”, respectively, the ratio of the corresponding drain current Id is 4:2:1.

The flow of a current when attention is paid to the ejection control portion 42 on the side of the first ejection control switches D4, D5, and D6 alone (the left half of FIG. 10) will now be described. Firstly, when F=0 (ON) and Dpx=0, the input to the NOR gate X1 is (0, 0) and the output is therefore 1. The transistor M1 thus comes ON. Also, the input to the NOR gate X2 is (0, 0) and the output is therefore 1. The transistor M2 thus comes ON. Further, in the above case (F=0 and Dpx=0), the input value to the NOR gate X3 is (1, 0) because the input value on one side is the value of F=0 and the input value on the other side is the value of Dpx=0 inverted to 1 via the NOT gate X4. The output of the NOR gate X3 is therefore 0. The transistor M4 thus goes OFF.

In this case, because the transistor M2 is ON, a current flows from the transistor M3 to the transistor M2. However, because the transistor M4 is OFF, a current will not flow from the transistor M5 to the transistor M4. Further, because of the characteristic of the CM circuit, a current will not flow through the transistor M3 when a current is not flowing through the transistor M5.

When a voltage of the resistor power supply Vh is applied in this state, a current will not flow to the transistors M3 and M5 because they are OFF. The current therefore does not branch to the transistors M3 and M5 and the entire current flows into the resistor Rh-A. Also, because the transistor M2 is ON, the current flown through the resistor Rh-A branches to the transistor M2 and the resistor Rh-B, which allows the current to flow out to the transistor M2. In this case, when all the first ejection control switches D6 through D4 are OFF, the current will not flow into the transistors M7, M9, and M11. Consequently, the current will not flow out to the transistor M2. The current flown through the resistor Rh-A therefore entirely flows into the resistor Rh-B. Further, the current flown through the resistor Rh-B flows through the transistor M1 that is ON, after which it is sent to the ground.

On the contrary, when at least one of the first ejection control switches D6 through D4 is ON, any one of the transistors M6, M8 and M10 corresponding to one of the first ejection control switches D6 through D4 that is ON comes ON. Further, any one of the transistors M7, M9, and M11 connected to this transistor comes ON. Accordingly, for example, when the first ejection control switch D6 is ON in the above case, a current flown through the resistor Rh-A branches to the transistor M2 and the resistor Rh-B and the current flows out to the transistor M2. Further, the current flown through the transistor M2 is sent to the ground by way of the transistors M7 and M6.

In other words, in a case where F=0 and Dpx=0, when at least one of the first ejection control switches D6 through D4 is ON, a current will not branch to the transistors M3 and M5. The entire current therefore flows through the resistor Rh-A and branches to the transistor M2 and the resistor Rh-B. Accordingly, a current I flown through the resistor Rh-A and the resistor Rh-B establishes a relation expressed as: I(Rh-A)>I(Rh-B), where I(**) is a current flowing through **.

Meanwhile, when F=0 and Dpx=1 are inputted, as with the above case, the input to the NOR gate X1 is (0, 0) and the output is therefore 1. The transistor M1 thus comes ON. Also, the input to the NOR gate X2 is (1, 0) and the output is therefore 0. The transistor M2 thus goes OFF. Further, the input to the NOR gate X3 is (0, 0) and the output is therefore 1. The transistor M4 thus comes ON. When the transistor M4 is ON, a current also flows through the transistor M5 and the current also flows through the transistor M3 because of the characteristic of the CM circuit.

Hence, when a voltage of the resistor power supply Vh is applied, a current flows into the resistor Rh-A and the transistors M3 and M5. The current flown through the resistor Rh-A entirely flows into the resistor Rh-B (this is because the transistor M2 is OFF, the current flows out from the resistor Rh-A does not branch to the transistor M2). Meanwhile, the current flown through the transistor M3 entirely flows into the resistor Rh-B because the transistor M2 is OFF. Accordingly, besides the current flown through the resistor Rh-A, the current flown through the transistor M3 flows into the resistor Rh-B. Consequently, the current I flown through the resistor Rh-A and the resistor Rh-B establishes a relation expressed as: I(Rh-A)<I(Rh-B).

In the above case, for a current to flow into the transistor M5, the transistor M4 has to be ON, and as has been described above, the transistor M4 comes ON when F=0 and Dpx=1 are inputted. Further, for a current to flow into the transistor M4, at least one of the transistors M7, M9, and M11 has to be ON. Hence, as in the case of F=0 and Dpx=0 described above, at least one of the first ejection control switches D6 through D4 has to be ON. More specifically, when all the first ejection control switches D6 through D4 are OFF, states are the same when F=0 and Dpx=1 and when F=0 and Dpx=0. The current flown through the resistor Rh-A therefore entirely flows into the resistor Rh-B. Hence, when the electrical resistance values of the resistors Rh-A and Rh-B are set to substantially the same value, an ink droplet is ejected without being deflected.

As has been described, by turning ON the ejection execution input switch F and controlling the ON and OFF switching of the polarity conversion switch Dpx and the first ejection control switches D6 through D4, the ejection control portion 42 becomes able to flow a current out from between the resistors Rh-A and Rh-B or to flow a current into between the resistors Rh-A and Rh-B. Also, because the capacities of the transistors M7, M9, and M11 functioning as the current source elements are all different, by controlling the ON and OFF switching of the first ejection control switches D6 through D4, it becomes possible to change an amount of a current to be flown out from the transistors M2 and M4. In short, by controlling the ON and OFF switching of the first ejection control switches D6 through D4, it becomes possible to change the value of a current flowing through the resistors Rh-A and Rh-B. Hence, by applying an adequate voltage Vx between the amplitude control terminal Z and the ground and operating the polarity conversion switch Dpx and the first ejection control switches D4, D5, and D6 independently, it becomes possible to vary the landing position of an ink droplet in multiple steps in the alignment direction of the nozzles 18. Further, by changing the voltage Vx applied to the amplitude control terminal Z, it becomes possible to vary an amount of deflection per step while maintaining the ratio of the drain current flowing into the transistors M7 and M6, the transistors M9 and M8, and the transistors M11 and M10 at 8:4:2.

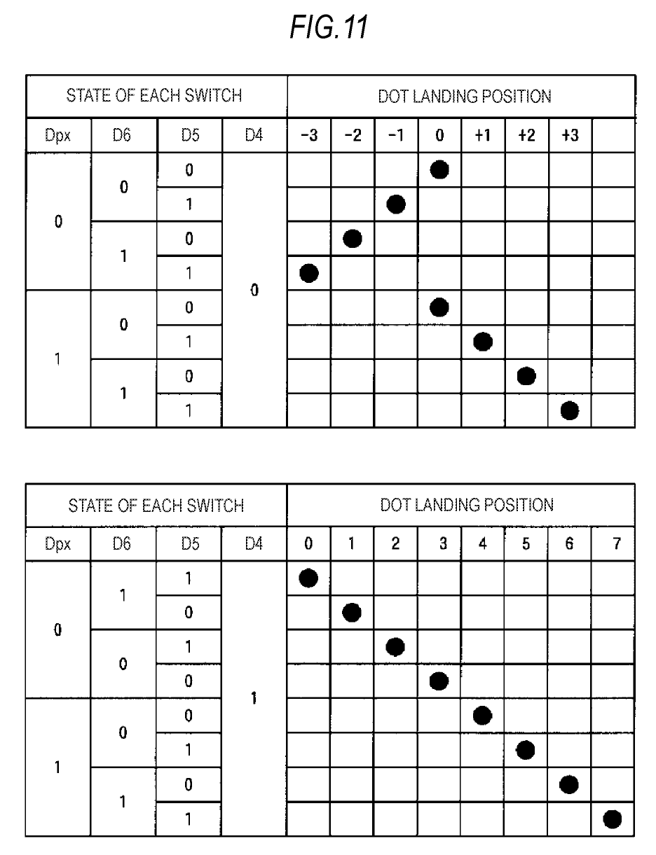

FIG. 11 is a view showing ON and OFF states of the polarity conversion switch Dpx and the first ejection control switches D6 through D4 and a variance of the landing position of a dot (ink droplet) in the alignment direction of the nozzles 18 in a tabular form. As is shown in the table in the upper row of FIG. 11, in a case where it is fixed as D4=0, when (Dpx, D6, D5, D4) is (0, 0, 0, 0) and (1, 0, 0, 0), the landing position of a dot is not deflected (directly below the nozzle 18). By performing the control using three bits, namely, the polarity conversion switch Dpx and the first ejection control switches D6 and D5, while the value of the first ejection control switch D4 is fixed to 0 (D4=0) as above, it becomes possible to vary the landing position of a dot step by step to seven points including the position without any deflection.

Instead of fixing the value of the first ejection control switch D4 to 0, by changing the value from 0 or 1 or vice versa in the same manner as with the other first ejection control switch D6 or D5, the landing position can be varied not to seven points but to 15 points.

On the contrary, as is shown in the table in the lower row, in a case where it is fixed as D4=1, it becomes possible to vary the landing position of a dot equally in eight steps. This configuration makes it possible to set the landing position of a dot at four points on one side and at four points on the other side having a position at which an amount of deflection is 0 (no deflection) at the center in the alignment direction of the nozzles 18. Also, this configuration makes it possible to set the landing position at the respective four points right-left symmetrical with respect to the point at which an amount of deflection is 0. In short, when it is fixed as D4=1, it becomes possible to eliminate a case where the landing position of a dot is directly below the nozzle 18 (no deflection).

The content described above relates to the first ejection control switches D4, D5, and D6. It should appreciated, however, that the second ejection control switches D3, D2, and D1 can be controlled in the same manner as the first ejection control switches D4, D5, and D6. As is shown in FIG. 10, the transistors M12 and M13 on the side of the second ejection control switches D3, D2, and D1 correspond, respectively, to the transistors M2 and M4 on the side of the first ejection control switches D4, D5, and D6. Also, the polarity conversion switch Dpy on the side of the second ejection control switches D3, D2, and D1 corresponds to the polarity conversion switch Dpx on the first ejection control switches D4, D5, and D6. Further, the transistors M14 through M19 functioning as the current source elements on the side of the second ejection control switches D3, D2, and D1 correspond, respectively, to the transistors M6 through M11 on the side of the first ejection control switches D4, D5, and D6. Further, the second ejection control switches D3, D2, and D1 on the side of the second ejection control switches D3, D2, and D1 correspond to the first ejection control switches D6, D5, and D4, respectively.

Also, a portion on the side of the second ejection control switches D3, D2, and D1 different from the side of the first ejection control switches D4, D5, and D6 is the capacities of the transistors M14 and so forth each functioning as the current source element. The transistors M14 and so forth each functioning as the current source element are set to have half the capacity of the corresponding transistors M7 and so forth each functioning as the current source element on the side of the first ejection control switches D4, D5, and D6. Other configurations are the same as those on the side of the first ejection control switches D4, D5, and D6.

Hence, as with on the side of the first ejection control switches D4, D5, and D6 described above, it becomes possible to change the value of a current flowing through the resistors Rh-A and Rh-B by controlling the ON and OFF switching of the second ejection control switches D3 through D1 together with the polarity conversion switch Dpy. On the side of the second ejection control switches D3, D2, and D1, it is rational to set the target landing positions of most remotely spaced two ink droplets to a distance comparable to one pitch of the nozzles 18. Also, on the second ejection control switches D3, D2, and D1, a finer variable pitch is preferable for the target landing positions of ink droplets.

Accordingly, on the side of the second ejection control switches D3, D2, and D1, it is rational to perform the control as set forth in the table in the lower row of FIG. 11. More specifically, regarding the configuration on the side of the second ejection control switches D3, D2, and D1 with reference to FIG. 10, the polarity conversion switch Dpx corresponds to the polarity conversion switch Dpy, the first ejection control switch D6 corresponds to the second ejection control switch D3, the first ejection control switch D5 corresponds to the second ejection control switch D2, and the first ejection control switch D4 corresponds to the second ejection control switch D1. It is therefore preferable to perform the control by fixing the value of the second ejection control switch D1 to 1 (D1=1). It should be appreciated, however, that the control corresponding to the table in the upper row of FIG. 11 may be performed as well.

On the side of the second ejection control switches D3, D2, and D1, the voltage Vx to be applied to the amplitude control terminal Z is set in such a manner that the target landing positions of the most remotely spaced two ink droplets will have a distance comparable to one pitch of the nozzles 18. Herein, the same amplitude control terminal Z is used for the control on the side of the second ejection control switches D3, D2, and D1 and for the control on the side of the first ejection control switches D4, D5, and D6. Hence, after the voltage Vx to be applied to the amplitude control terminal Z is set by taking the control on the side of the second ejection control switches D3, D2, and D1 into account, the landing position of an ink droplet on the side of the first ejection control switches D4, D5, and D6 is determined according to the voltage Vx thus set.

Accordingly, by controlling ejection of an ink droplet on the side of the second ejection control switches D3, D2, and D1, that is, by determining an interval of the landing positions of ink droplets while a certain relation is maintained between the control on ejection of an ink droplet on the side of the first ejection control switches D4, D5, and D6 and the control on ejection of an ink droplet on the side of the second ejection control switches D3, D2, and D1, the control on ejection of an ink droplet on the side of the first ejection control switches D4, D5, and D6 is determined on the basis of the determination result.

In addition, by making the determination as above, the interval of the landing positions of two ink droplets at the most remotely spaced positions on the side of the first ejection control switches D4, D5, and D6 becomes twice the interval on the side of the second ejection control switches D3, D2, and D1. This is attributed to a difference that an amount of deflection of the ejection direction of an ink droplet is determined by the transistors M7, M9 and M11 on the side of the first ejection control switches D4, D5, and D6 whereas it is determined by the transistors M14, M15, and M16 on the side of the second ejection control switches D3, D2, and D1 and the capacities of the transistors on the first ejection control switches D4, D5, and D6 are set to values two times as large as the capacities of the corresponding transistors on the second ejection control switches D3, D2, and D1.

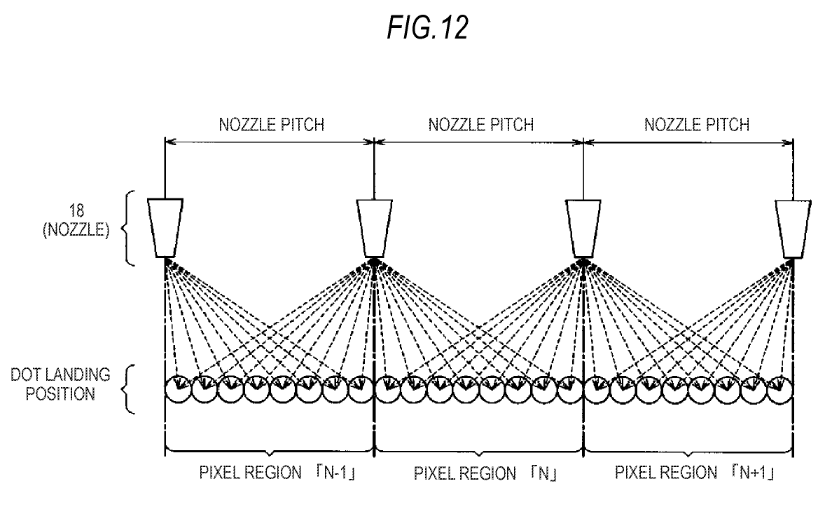

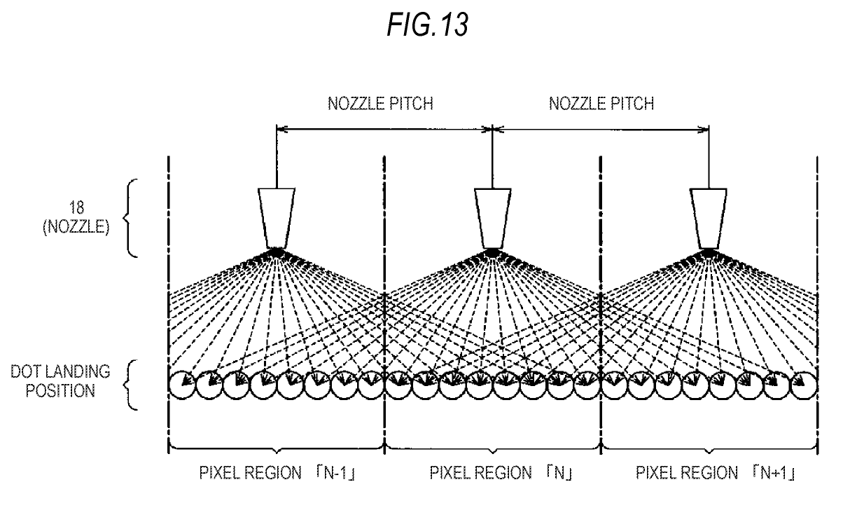

FIG. 12 and FIG. 13 are views showing ejection directions of ink droplets and a distribution state of dot landing positions when control is performed on the side of the first ejection control switches D4, D5, and D6 and on the side of the second ejection control switches D3, D2, and D1.

FIG. 12 shows a case where there are even-numbered ejection directions of ink droplets by the control on the side of the first ejection control switches D4, D5 and D6, that is, in a case where the nozzles 18 are positioned directly above between pixel regions. FIG. 12 shows an example where dots are landed on the pixel regions on right and left per ½ pitch by the control on the side of the first ejection control switches D4, D5, and D6.

FIG. 13 shows a case where there are odd-numbered ejection directions of ink droplets by the control on the side of the first ejection control switches D4, D5, and D6, that is, in a case where the nozzles 18 are positioned directly above the center of pixel regions. FIG. 13 shows an example where dots are landed on the pixel regions on right and left per pitch by the control on the side of the first ejection control switches D4, D5, and D6.

In the printer device 1 configured as above, a pair of the heat elements 16a and 16b is provided in each ink liquid chamber 21. Hence, the flight characteristic of an ink droplet may differ from one product to another or due to factors, such as deterioration with time. Accordingly, in order to form a high-quality image, it is necessary to confirm the flight characteristic for each product or at regular periods or each time printing is performed.

To this end, the printer device 1 is configured to confirm the flight characteristic for each product or at regular periods or each time printing is performed. To be more concrete, the printer device 1 reads out test data stored in the ROM 44 and prints a test pattern on a recording sheet P according to the test data. It then reads a landing pattern of the ink i of the printed test pattern using the line scanner 36 to detect the landing position of an ink droplet i according to an output signal from the line scanner 36. Upon detection of a deviation of the landing position, it corrects the ejection direction of the ink droplet i according to an amount of the deviation. The ejection direction of the ink droplet i is adjusted by determining an amount of a current to be supplied to the heat elements 16a and 16b by the ejection control portion 42 in such a manner that an amount of the deviation is reduced to 0. For example, when it is detected that the ink droplet i is deviated by a certain amount in one direction, the control portion 46 adjusts an amount of a current to be supplied to the heat elements 16a and 16b so that an ink droplet i is deviated by the certain amount in the other direction.

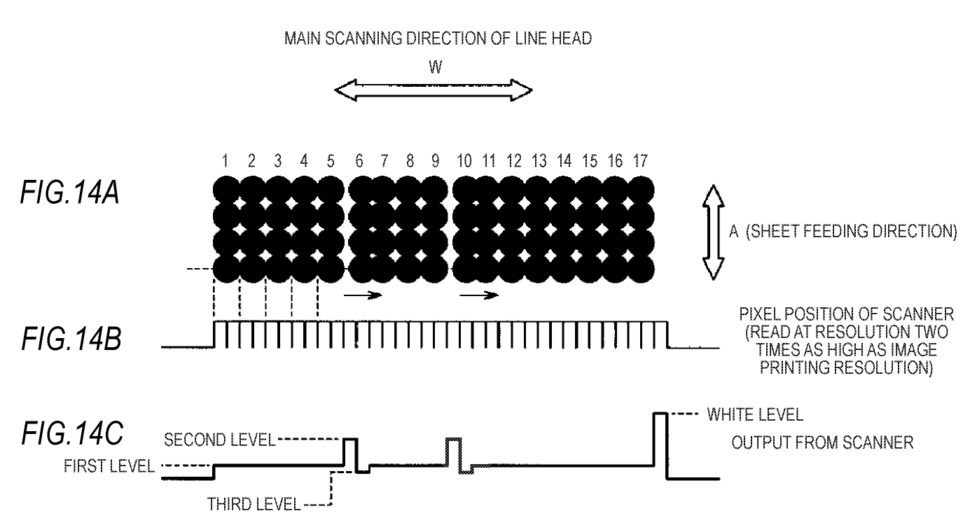

A more concrete description will be given. FIG. 14A shows a landing pattern according to the test data. FIG. 14B shows the pixel positions read by the line scanner 36. FIG. 14C shows an output of the line scanner 36 for the landing pattern, that is, the luminance level. In the landing pattern shown in FIG. 14A, dots in the sixth column and the tenth column come closer to the right side of the drawing (see arrows). Hence, white streaks or low density streaks are formed between the fifth column and the sixth column and between the ninth column and the tenth column whereas dark streaks are formed between the sixth column and the seventh column and between the tenth column and the eleventh column adjacent to these white or low density streaks.

Herein, the line scanner 36 has resolution two times as high as the resolution of the line head 13. Hence, as is shown in FIG. 14B, the line scanner 36 has a relation to read one dot from two pixels.

Accordingly, as is shown in FIG. 14C, in the luminance level of data outputted from the line scanner 36, a portion printed in the first column is a first level at the beginning and the luminance level rises to a second level (lighter portion) between the fifth column and the sixth column and between the ninth column and the tenth column. Subsequently, the luminance level drops to a third level (darker portion), which is lower than the first level, between the sixth column and the seventh column and between the tenth column and the eleventh column. Subsequently, the luminance level returns to the first level from the seventh column and from the eleventh column. The luminance level then rises to a white level after the sixteenth column at which the landing pattern ends.

The control portion 46 detects a variance pattern of the luminance level of an output signal from the line scanner 36. To be more concrete, for example, after normalization, the control portion 46 determines whether the luminance level exceeds a first threshold value corresponding to the first level on the lighter side first and thence whether the luminance level exceeds a second threshold value corresponding to the second level on the darker side. When the luminance level from one side (on the left side of FIGS. 14A through 14C) exceeds the first threshold value first and thence exceeds the second threshold value (a pattern in order of convex and concave), as is shown in FIG. 14A, the control portion 46 determines that dots in specific columns, for example, dots in the sixth column and the tenth column, come closer to the right side of the drawing. In this case, ink droplets i flew in a curve rightward from the determined direction. Hence, the control portion 46 controls the heat elements 16a and 16b using the ejection control portion 42 in such a manner that ink droplets i are ejected leftward, so that the ink droplets i will be ejected in the predetermined direction.

In a case where an inverse pattern of the pattern of FIG. 14C, that is, a pattern in order of concave and convex is detected, the control portion 46 determines that dots come closer to the left side of the drawing and ink droplets i flew in a curve in the leftward from the predetermined direction. In this case, the control portion 46 controls the heat elements 16a and 16b using the ejection control portion 42 in such a manner that ink droplets i are ejected rightward, so that the ink droplets i will be ejected in the predetermined direction.

As has been described, the line scanner 36 is configured to have the read resolution two or more times as high as the resolution of the line head 13. Herein, it is configured to read an image at resolution two times as high as the resolution of the line head 13. Hence, the printer device 1 is able to prevent a beat in an output signal from the line scanner 36 occurring in a case where the resolution of the line scanner 36 and the resolution of the line head 13 coincide or substantially coincide with each other. Consequently, the printer device 1 becomes able to determine precisely the landing position of an ink droplet i, which enables the ejection control portion 42 to exactly correct the ejection direction of an ink droplet i.

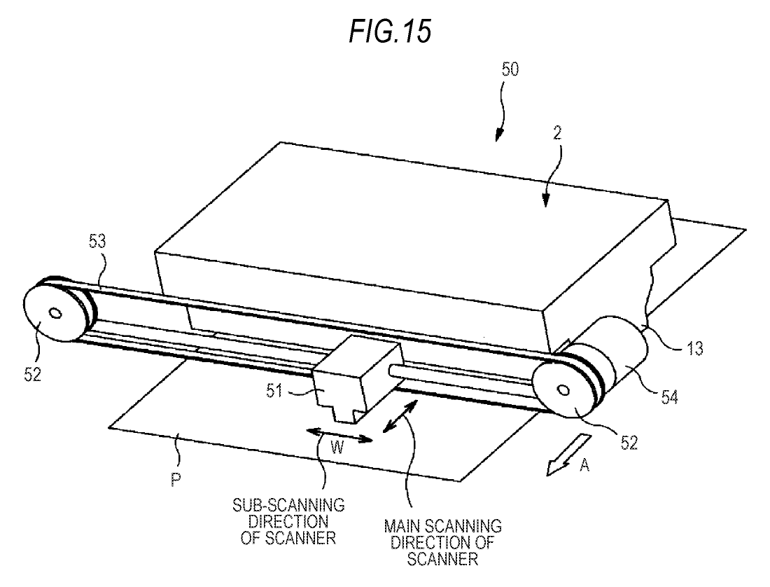

A modification of the printer device 1 will now be described with reference to FIG. 15. A printer device 50 shown in FIG. 15 is characterized in that a scanner provided therein is a scanner 51 that moves in a direction orthogonal to the transportation direction of a recording sheet P in contrast to the printer device 1 using the line scanner 36 as described above. More specifically, in the printer device 50, the main scanning direction of the scanner 51 is orthogonal to the main scanning direction of the line head 13 and the sub-scanning direction of the scanner 51 is the same as the main scanning direction of the line head 13.

Herein, an endless belt 53 is stretched over a pair of pulleys 52 and 52 and the scanner 51 is attached to the endless belt 53. The scanner 51 therefore moves in a direction to traverse a recording sheet P as one of the pulleys 52 is driven to rotate by a motor 54.

The printer device 50 is configured in such a manner that the scanner 51 reads an image at resolution in the sub-scanning direction orthogonal to the transportation direction of a recording sheet P two or more times as high as the resolution of the line head 13, herein, at the resolution two times as high as the resolution of the line head 13. As has been described above using FIGS. 14A through 14C, the printer device 50 also detects a variance pattern of the luminance level of an output signal from the scanner 51 to detect the direction of a deviation and an amount of the deviation of the landing position of an ink droplet i and corrects the deviation.

Hence, in the printer device 50, too, it is possible to prevent a beat in an output signal from the scanner 51 occurring when the resolution of the scanner 51 and the resolution of the scanner 13 coincide or substantially coincide with each other. Accordingly, the printer device 50 becomes able to precisely determine the landing position of an ink droplet i, which enables the ejection control portion 42 to exactly correct the ejection direction of an ink droplet i.

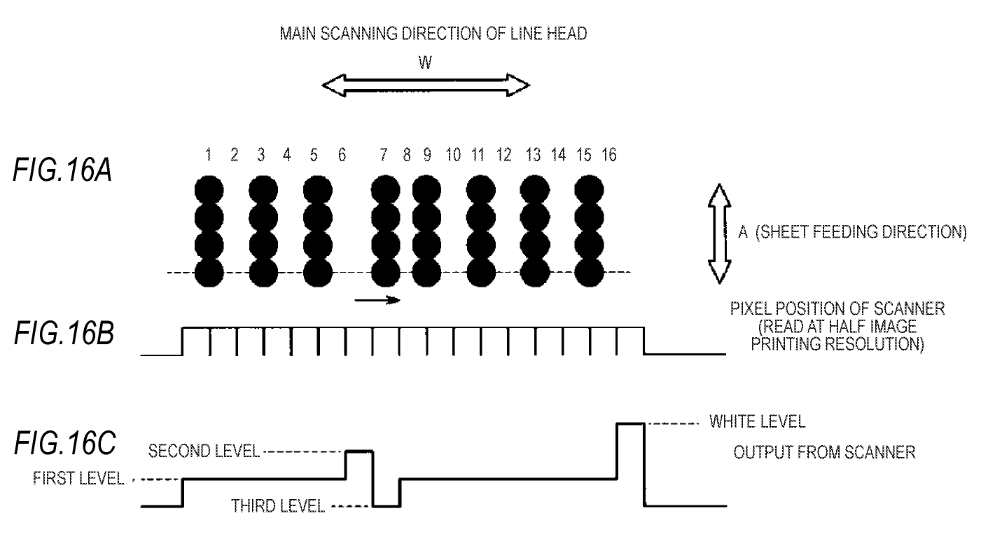

Further, a modification of the printer devices 1 and 50 will now be described with reference to FIGS. 16A through 16C. In contrast to the printer devices 1 and 50 respectively provided with the scanner 36 and 51 having resolution two or more times as high as the resolution of the line head 13, the resolution of the line head 13 and the resolution of the scanners 36 and 51 are substantially the same herein. As has been described, when the resolution of the scanners 36 and 51 and the resolution of the line head 13 coincide or substantially coincide with each other, a beat may occur in an output signal from the scanners 36 and 51. Such being the case, the line head 13 prints an image at half or below half the resolution of the scanners 36 and 51.

To be more concrete, FIG. 16A shows a landing pattern according to the test data when the resolution of the line head 13 is set to half. FIG. 16B shows positions of pixels read by the scanners 36 and 51. FIG. 16C shows an output of the scanner 36 and 51 for the landing pattern, that is, the luminance level. In the landing pattern shown in FIG. 16A, dots in the seventh column come closer to the right side of the drawing (see an arrow). Accordingly, a white streak or a low density streak is formed between the fifth column and the seventh column whereas a dark streak is formed between the seventh column and the ninth column adjacent to the white or low density streak.

Herein, the scanners 36 and 51 have resolution two times as high as the dot pattern thus formed. Hence, as is shown in FIG. 16B, the scanners 36 and 51 have a relation to read one dot from two pixels.

Consequently, as is shown in FIG. 16C, in the luminance level of the data outputted from the scanners 36 and 51, a portion printed in the first column is a first level at the beginning and the luminance level rises to a second level (lighter portion) between the fifth column and the seventh column. Subsequently, the luminance level drops to a third level (darker portion), which is lower than the first level, between the seventh column and the ninth column. Subsequently, the luminance level returns to the first level from the ninth column.

The control portion 46 detects a variance pattern of the luminance level of an output signal from the scanners 36 and 51. To be more concrete, for example, after normalization, the control portion 46 determines whether the luminance level exceeds a first threshold value corresponding to the first level on the lighter side first and thence determines whether the luminance level exceeds a second threshold value corresponding to the second level on the darker side. When the luminance level from one side (left side of FIGS. 16A through 16C) exceeds the first threshold value first and thence the second threshold value (a pattern in order of convex and concave), the control portion 46 determines that dots in specific columns, for example, dots in the seventh column as is shown in FIG. 16A, come closer to the right side of the drawing. In this case, ink droplets i flew in a curve rightward from the predetermined direction. Accordingly, the control portion 46 controls the heat elements 16a and 16b using the ejection control portion 42 in such a manner that ink droplets i are ejected leftward, so that the ink droplets i will be ejected in the predetermined direction.

In this example, the line head 13 prints an image at half or below half the resolution of the scanners 36 and 51 by shifting one pixel. In other words, dots are formed in even-numbered columns of FIG. 16A and the control portion 46 makes a determination in the same manner as above.

When an inverse pattern of the pattern of FIG. 16C, that is a pattern in order of concave and convex is detected, the control portion 46 determines that dots come closer to the left side of the drawing and ink droplets i flew in a curve leftward from the predetermined direction. In this case, the control portion 46 controls the heat elements 16a and 16b using the ejection control portion 42 in such a manner that ink droplets i are ejected rightward, so that the ink droplets i will be ejected in the predetermined direction.

According to the example described as above, it is also possible to prevent a beat in an output signal from the scanners 36 and 51 occurring when the resolution of the scanners 36 and 51 and the resolution of the line head 13 coincide or substantially coincide with each other. It thus becomes possible to precisely determine the landing position of an ink droplet i in this example, too, which enables the ejection control portion 42 to exactly correct the ejection direction of an ink droplet i.

The present application contains subject matter related to that disclosed in Japanese Priority Patent Application JP 2008-209284 filed in the Japan Patent Office on Aug. 15, 2008, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A liquid ejection device comprising:
a line head that has a plurality of liquid chambers storing liquid, heater elements provided at least in a pair aligned side by side in each liquid chamber to generate bubbles by heating the liquid stored in the liquid chamber, and a nozzle that is provided at a position substantially opposing a plurality of the heater elements within each liquid chamber and ejects a droplet from the liquid chamber using the bubbles generated by the heater elements, and is provided to be substantially orthogonal to a transportation direction of a recording medium on which the droplet is to land;
an ejection control portion that controls an ejection direction of the droplet ejected from the nozzle to be a direction substantially orthogonal to the transportation direction of the recording medium by providing a difference in energy to be applied to the plurality of the heater elements within each liquid chamber;
a line scanner that has resolution two or more times as high as resolution of the line head and is provided to be substantially orthogonal to the transportation direction of the recording medium to detect a landing pattern made up of droplets landed on the recording medium; and
control means for detecting a variance pattern of a luminance level of an output signal outputted from the line scanner to detect a deviation of a landing position of the droplet on the basis of the variance pattern of the luminance level and for correcting the ejection direction of the droplet to be a direction in which the deviation is eliminated by controlling the ejection control portion.

2. A liquid ejection method comprising the steps of:
ejecting a droplet on a recording medium, using a line head that has a plurality of liquid chambers storing liquid, heater elements provided at least in a pair aligned side by side in each liquid chamber to generate bubbles by heating the liquid stored in the liquid chamber, and a nozzle that is provided at a position substantially opposing a plurality of the heater elements within each liquid chamber and ejects the droplet from the liquid chamber using the bubbles generated by the heater elements, and is provided to be substantially orthogonal to a transportation direction of the recording medium on which the droplet is to land, while controlling an ejection direction of the droplet ejected from the nozzle to be a direction substantially orthogonal to the transportation direction of the recording medium by providing a difference in energy to be applied to the plurality of the heater elements within each liquid chamber;
detecting a landing pattern made up of droplets landed on the recording medium using a line scanner having resolution two or more times as high as resolution of the line head and provided to be substantially orthogonal to the transportation direction of the recording medium; and
detecting a variance pattern of a luminance level of an output signal outputted from the line scanner to detect a deviation of a landing position of the droplet on the basis of the variance pattern of the luminance level and correcting the ejection direction of the droplet to be a direction in which the deviation is eliminated.

3. A liquid ejection device comprising:
a line head that has a plurality of liquid chambers storing liquid, heater elements provided at least in a pair aligned side by side in each liquid chamber to generate bubbles by heating the liquid stored in the liquid chamber, and a nozzle that is provided at a position substantially opposing a plurality of the heater elements within each liquid chamber and ejects a droplet from the liquid chamber using the bubbles generated by the heater elements, and is provided to be substantially orthogonal to a transportation direction of a recording medium on which the droplet is to land;
an ejection control portion that controls an ejection direction of the droplet ejected from the nozzle to be a direction substantially orthogonal to the transportation direction of the recording medium by providing a difference in energy to be applied to the plurality of the heater elements within each liquid chamber;
a scanner that has resolution two or more times as high as resolution of the line head and is configured to move in a direction substantially orthogonal to the transportation direction of the recording medium to detect a landing pattern made up of droplets landed on the recording medium; and
control means for detecting a variance pattern of a luminance level of an output signal outputted from the scanner to detect a deviation of a landing position of the droplet on the basis of the variance pattern of the luminance level and for correcting the ejection direction of the droplet to be a direction in which the deviation is eliminated by controlling the ejection control portion.

4. A liquid ejection method comprising the steps of:
ejecting a droplet on a recording medium, using a line head that has a plurality of liquid chambers storing liquid, heater elements provided at least in a pair aligned side by side is provided in each liquid chamber to generate bubbles by heating the liquid stored in the liquid chamber, and a nozzle that is provided at a position substantially opposing a plurality of the heater elements within each liquid chamber and ejects the droplet from the liquid chamber using the bubbles generated by the heater elements, and is provided to be substantially orthogonal to a transportation direction of the recording medium on which the droplet is to land, while controlling an ejection direction of the droplet ejected from the nozzle to be a direction substantially orthogonal to the transportation direction of the recording medium by providing a difference in energy to be applied to the plurality of the heater elements within each liquid chamber;
detecting a landing pattern made up of droplets landed on the recording medium by moving a scanner having resolution two or more times as high as resolution of the line head in a direction substantially orthogonal to the transportation direction of the recording medium; and
detecting a variance pattern of a luminance level of an output signal outputted from the scanner to detect a deviation of a landing position of the droplet on the basis of the variance pattern of the luminance level and correcting the ejection direction of the droplet to be a direction in which the deviation is eliminated.

5. A liquid ejection device comprising:
a line head that has a plurality of liquid chambers storing liquid, heater elements provided at least in a pair aligned side by side in each liquid chamber to generate bubbles by heating the liquid stored in the liquid chamber, and a nozzle that is provided at a position substantially opposing a plurality of the heater elements within each liquid chamber and ejects a droplet from the liquid chamber using the bubbles generated by the heater elements, and is provided to be substantially orthogonal to a transportation direction of a recording medium on which the droplet is to land;
an ejection control portion that controls an ejection direction of the droplet ejected from the nozzle to be a direction substantially orthogonal to the transportation direction of the recording medium by providing a difference in energy to be applied to the plurality of the heater elements within each liquid chamber;
a scanner that has resolution substantially as high as resolution of the line head and detects a landing pattern made up of droplets landed on the recording medium; and
control means for detecting a variance pattern of a luminance level of an output signal outputted from the scanner to detect a deviation of a landing position of the droplet on the basis of the variance pattern of the luminance level and for correcting the ejection direction of the droplet to a direction in which the deviation is eliminated,
wherein the ejection control means forms the landing pattern on the recording medium by causing droplets to be ejected at half or below half the resolution of the scanner so that the landing pattern is detected by the scanner.

6. A liquid ejection method comprising the steps of:
ejecting a droplet on a recording medium, using a line head that has a plurality of liquid chambers storing liquid, heater elements provided at least in a pair aligned side by side in each liquid chamber to generate bubbles by heating the liquid stored in the liquid chamber, and a nozzle that is provided at a position substantially opposing a plurality of the heater elements within each liquid chamber and ejects the droplet from the liquid chamber using the bubbles generated by the heater elements, and is provided to be substantially orthogonal to a transportation direction of the recording medium on which the droplet is to land, while controlling an ejection direction of the droplet ejected from the nozzle to be a direction substantially orthogonal to the transportation direction of the recording medium by providing a difference in energy to be applied to the plurality of the heater elements within each liquid chamber;
detecting a landing pattern made up of droplets landed on the recording medium using a scanner having resolution substantially as high as resolution of the line head; and
detecting a variance pattern of a luminance level of an output signal outputted from the scanner to detect a deviation of a landing position of the droplet on the basis of the variance pattern of the luminance level and correcting the ejection direction of the droplet to a direction in which the deviation is eliminated,
wherein the line head forms the landing pattern on the recording medium by causing droplets to be ejected at half or below half the resolution of the scanner so that the landing pattern is detected by the scanner.
